(19) United States
(12) Patent Application Publication
(10) Pub. No.: US 2026/0295947 A1
(43) Pub. Date: Oct. 1, 2026

(54) Multilayer Fabric Welder

(71) Applicant: Shengwei Liang, Vista, CA (US)

(72) Inventor: Shengwei Liang, Vista, CA (US)

(21) Appl. No.: 19/097,794

(22) Filed: Apr. 1, 2025

(51) Int. Cl. B29C 65/20; B29C 65/72

(52) U.S. Cl. CPC B29C 65/20; B29C 65/72

(57) ABSTRACT

A welder is provided for welding the perimeter edges of polymeric products which are formed of multiple layers of polymeric fabric sheets, such as inflatable products. Supported on a cross member above the product, the welder is maneuverable along a circumferential pathway around the perimeter edge of the product to weld it without substantially moving a central area of the stacked layers forming the product from a support table.

### FIELD OF THE INVENTION

The disclosed device relates to welding machines for attachment of fabric layers to each other. More particularly, it relates to a fabric welding machine configured to follow a circular pathway around a side edge portion of stacked layers of polymeric fabric, which are to be welded, which remain substantially stationary during the welding process.

### BACKGROUND OF THE INVENTION

In the field of plastic and polymeric fabric sheets for inflatables or for other purposes where widths of polymeric fabrics must be joined, there are a number of techniques employed. Plastic or polymer fabric can be fused or welded using various techniques that involve heat, pressure, or chemical bonding.

One common method is hot air welding, where a stream of heated air softens the polymer surfaces, allowing them to fuse when pressed together. This technique is widely used in industries like roofing, banner production, and inflatable structures. It requires a controlled temperature to prevent burning or degrading the material while ensuring a strong bond. The welded seam is often rolled or pressed immediately after heating to create a smooth and durable joint.

Another widely used technique is heat sealing or hot wedge welding, which involves the use of a heated metal wedge or bar that presses the polymer fabrics together as they pass through a machine. This method ensures a consistent, waterproof, and airtight bond, making it ideal for applications like tents, tarpaulins, and industrial fabric structures. The process allows for precise control over temperature and pressure, which helps in achieving high-quality, uniform welds. Some heat sealing machines use impulse heating, where electricity quickly heats the welding element and then cools it to solidify the bond.

For certain types of polymer fabrics, ultrasonic welding can also be used. This process utilizes high-frequency vibrations to generate heat at the molecular level, causing the plastic to soften and bond without the need for external heat sources. Ultrasonic welding is commonly used for delicate or thin polymer materials, such as medical textiles and filtration fabrics, where excessive heat could cause damage. The method is fast, clean, and energy-efficient, making it a preferred choice in precision industries. Each of these fusion techniques provides a strong and reliable way to join polymer fabrics for different applications.

Conventionally, the polymeric fabric being joined must be moved through the welding machine. This can be a long and time consuming process where there are multiple layers being welded or fused and the constant movement can lead to less than perfect fused or welded seam formation.

In this respect, before explaining at least one embodiment of the fabric welding system for fabric which remains stationary herein in detail, it is to be understood that the tracked fabric welder is not limited in its application to the details of construction and to the arrangement of the components set forth in the following description or illustrated in the drawings, nor the steps outlined in the specification.

Also, it is to be understood that the phraseology and terminology employed herein are for the purpose of description of the tracked fabric welder system, and should not be regarded as limiting in any manner. As such, those skilled in the art will appreciate that the conception upon which this disclosure is based may readily be utilized as a basis for designing other methods and systems for carrying out the several purposes for the tracked fabric welder system and device disclosed herein. It is important, therefore, that the claims be regarded as including such equivalent construction insofar as they do not depart from the spirit and scope of the present invention.

### OBJECTS OF THE INVENTION

An object of this invention is the provision of a polymeric fabric welder for multiple layers of fabric, which allows a central portion of the fabric forming the product to remain substantially stationary on a support surface during the welding or fusing process of the perimeter edge portion of the fabric.

It is another object of this invention to provide a system to form a sealed engagement around the perimeter edge of multiple layers of stacked fabric.

It is a further object of this invention to provide such a welder to allow for stationary positioning of the welded product which will concurrently reinforce the perimeter edge of the stacked fabric being welded.

These, together with other objects and advantages of the disclosed fabric welding system herein, which will become subsequently apparent to those skilled in the art, reside in the details of the device construction and method herein as more fully hereinafter described and claimed, reference being had to the accompanying drawings forming a part thereof, wherein like numerals refer to like parts throughout.

### SUMMARY OF THE INVENTION

The system herein provides a fabric welder for the joining of multiple layers of polymeric or plastic fabric at a seamed edge portion, which is welded. By the term welding or welder herein is meant either joining the multiple fabric layers using a component which generates sufficient heat to the perimeter edge portion to fuse the two layers of fabric forming a product together. Such may be for example by hot air welding from hot air generators, or by the use of RF welding, or hot wedge welding or ultrasonic welding, or other welding with other heating components which cause areas at, and/or adjacent, the perimeter edge portion of stacked multiple layers of polymeric fabric to melt or fuse together.

In use commercially, layers or sections of polymeric fabric such polyvinyl chloride (PVC) or vinyl, or polyurethane, may be fused or welded together to form a product. Such is common with other polymeric fabrics such as drop stitch material. This welding or fusing of multiple layers is a conventional manner to manufacture large pieces of polymeric fabric from smaller rolls or sections of such. It is also a conventional practice to form inflatable products such as inflatable floats and water craft.

The system herein provides significant improvement in this process through the provision of a track-mounted welding component. The track-mounting welding component is supported in an elevated position by a support member operatively engaged with one or a plurality of overhead tracks. The overhead track allows the welding component, engaged to the support member, to slide along a path substantially parallel therewith.

Additionally, a sliding coupling to the support cross member allows the welding component to move sideways along the support member and perpendicular to the overhead track. The welding component is also rotationally engaged to the support member and thus may turn or rotate as need be to maintain an edge portion of stacked polymeric material correctly positioned to be welded without the need to move the stacked layers of polymeric material during the process.

The ability to slide the welder along the fabric adjacent the overhead track, and to slide the welder perpendicular to the overhead track on the cross member, allows an opening on the welding component to move around the perimeter of the stacked layers of fabric being welded, which are on a support surface such as a table, and to fuse or weld an edge portion adjacent the perimeter edge of the stacked material sheets. This configuration allows the stacked polymeric material to remain in a substantially stationary position upon the support platform or table while the welding component welds around the perimeter thereof. By substantially stationary herein is meant that a central area of the stacked layers forming the product are supported upon the table, while an edge portion thereof is flexed or lifted from the support surface to thereby run it through an opening and through the welding component.

In operation, an edge portion of the stacked sheets of polymeric fabric at or adjacent the perimeter edge thereof, is aligned with and fed through an opening located on one side of the welding component. In, or adjacent, that opening is operatively positioned the welder such that the welding component moves around the perimeter edge of the stacked polymeric fabric layers, the welder communicates sufficient heat to weld or fuse them together at the perimeter edge portion and/or an area adjacent thereto. By operatively positioned herein is meant that the welder is located on the welding component in or adjacent to the opening in a position and manner such that it will operate to communicate heat to weld or fuse the stacked layers of polymeric fabric to each other in a weld area at and/or adjacent to the perimeter edge portion of the stacked polymeric fabric.

The opening may have a folder therein or in a position having a trailing edge adjacent thereto. This folder is configured to feed a reinforcing layer or segment into a “C” shape where it is folded over the perimeter edge of the stacked layers of polymeric fabric. The folder may also fold end portions of the two layers of polymeric material to place their ends within the interior cavity of the formed product.

The reinforcing layer is formed of a polymeric material also such that it will be welded to the perimeter edge of the stacked sheets or layers of the polymeric material by the welder. In operation half of the reinforcing segment will be fused to the uppermost sheet of polymeric material in the stack and half will be fused by the welder to the lowermost layer.

The user having the multiple layers of polymeric material of the same dimensions formed in a stack which yields the intended product, may position the stack upon a support platform or table. Thereafter, an edge portion around the perimeter edge of the stacked material may be positioned within the opening in the welding component. With this edge portion so positioned, the welding component may be pulled or pushed around the perimeter edge of the stacked layers of polymeric material with the edge portion therein, and the welder operatively positioned in or adjacent the opening, will operate to fuse or weld portions of the layers of polymeric material in the stack to each other. Where the folder and reinforcing material is employed, it will be fed over the inserted edge portion, and will itself be fused or welded around the perimeter edge of the stacked polymeric material forming the fabric product.

With respect to the above description then, it is to be realized that the dimensional relationships and components of the multilayer polymeric fabric welder and method herein may also include variations in size, materials, shape, form, function and manner of operation, manner of formation, assembly, and use, which are deemed readily apparent and obvious to one skilled in the art subsequent to their review of this specification. Therefore, the foregoing summary and following description are considered as illustrative only of the principles of the multilayer polymeric fabric welding invention and method herein.

Further, since numerous modifications and changes will readily occur to those skilled in the art subsequent to their review of this disclosure, it is not desired to limit the multilayer polymeric fabric welding invention to the exact construction and operation and steps of employment shown and described. Accordingly, all suitable modifications and equivalent components and construction, which may be substituted or resorted to, are considered to fall within the scope of the invention herein.

### BRIEF DESCRIPTION OF THE DRAWINGS

The accompanying drawings, which are incorporated herein and form a part of the specification, illustrate some but not the only or exclusive examples of embodiments of the multilayer polymeric fabric welder. It is intended that the embodiments and figures disclosed herein are to be considered illustrative of preferred modes of the fabric welding and sealing device and the system, rather than limiting.

FIG. 1 shows an overhead depiction of a multilayer polymeric fabric product, which is positioned on a support table with an edge thereof within an opening of the welding component and shows the welding component invention herein rotationally coupled to a cross member which is slidably coupled to one or a plurality of overhead support members.

FIG. 2 shows the device and system of FIG. 1, wherein the welding component can follow an elliptical path to weld the perimeter edge of the stacked polymeric layers forming the product while leaving the stack substantially unmoved on the table.

FIG. 3 depicts the circumferential pathway the welding can follow using the rotational support thereof upon the cross member which will slide on the overhead support.

FIG. 4 shows the welding component rotationally coupled to the cross member from a view where an edge portion of the stacked layers forming the product is located in an opening of the welding component and an edge portion along the perimeter edge of a plurality of layers of polymeric is welded along with concurrently attaching a reenforced edge.

FIG. 5 shows a side view of the device and system as in FIG. 4 wherein biased wheels contact opposing sides of the polymeric layers forming a reinforced circumferential edge of the formed product is attached.

### DETAILED DESCRIPTION OF THE INVENTION

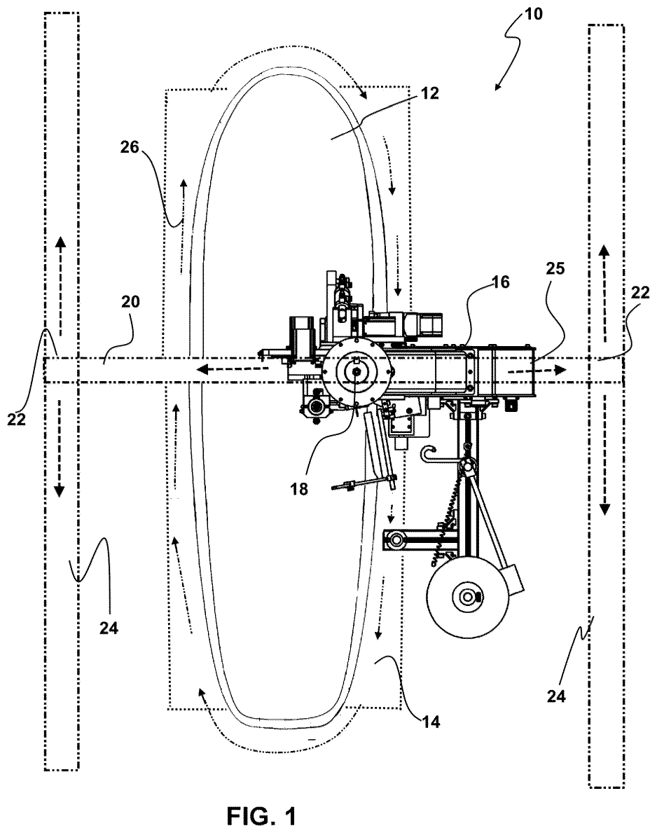

Referring now to the drawings in FIGS. 1-5, wherein similar components of the fabric welder device 10 are shown by like numbers. In FIG. 1, there is depicted an overhead view of a multilayer polymeric fabric product 12 which is positioned on a support table 14. Also shown is the welding component 16 rotationally coupled 18 to a cross member 20 which is slidably coupled 22 to one or a plurality of overhead support members 24. This rotational coupling 18 may be placed upon, or to, a sliding mount 25 positioned upon the cross member 20 to thereby allow the welding component 16 to both rotate and slide in the engagement to the overhead cross member 20.

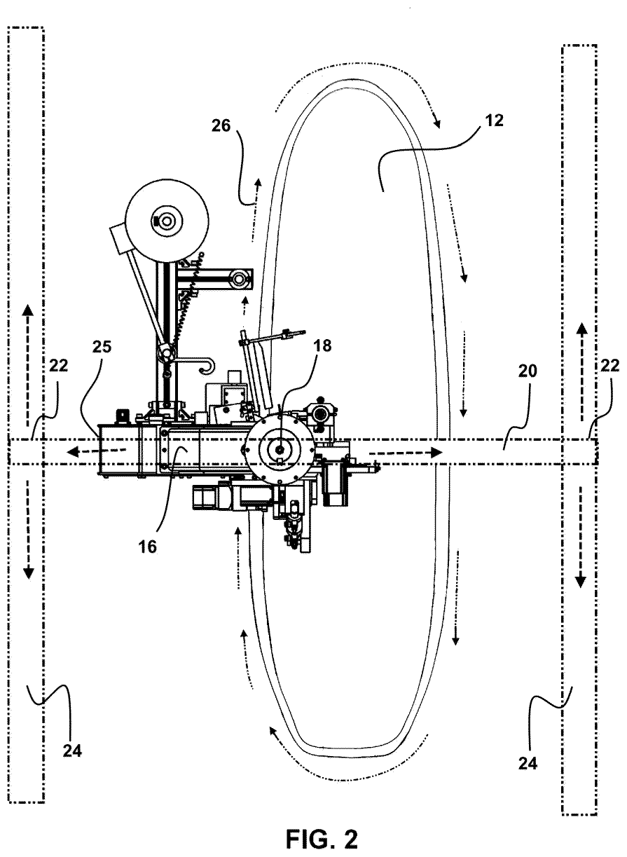

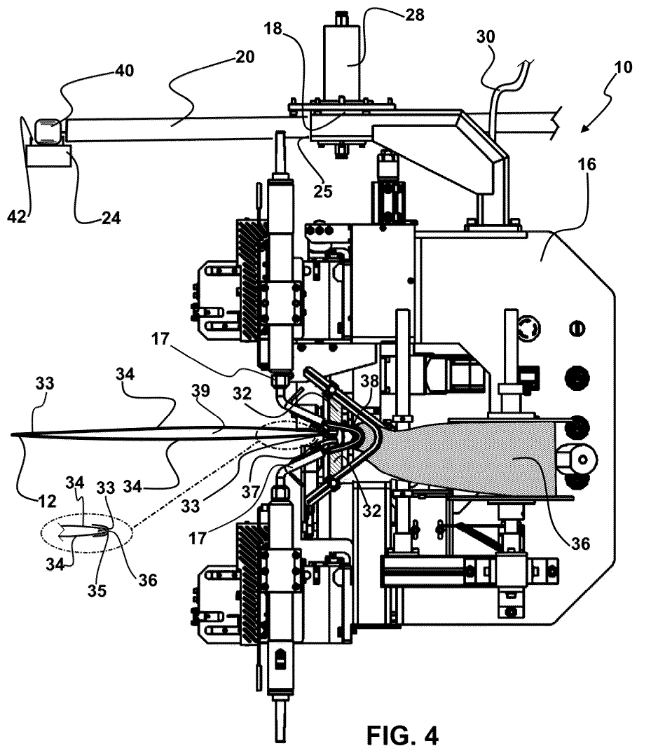

Also shown in FIGS. 1-2 is the circumferential pathway 26 the welding component 16 can follow allowing the welding of an edge portion 33 (FIG. 4) around the circumferential edge of the fabric product 12 during use. As shown the circumferential pathway 26 followed by the supported welding component 16 is an oval, however, it could be rectangular, round, triangular, or other shapes since the device 10 is configured to allow the fabric product 12 to remain substantially static in its position upon a table 14 while the welding component 16 welds the edge portion 33 around the perimeter edge of the fabric product 12.

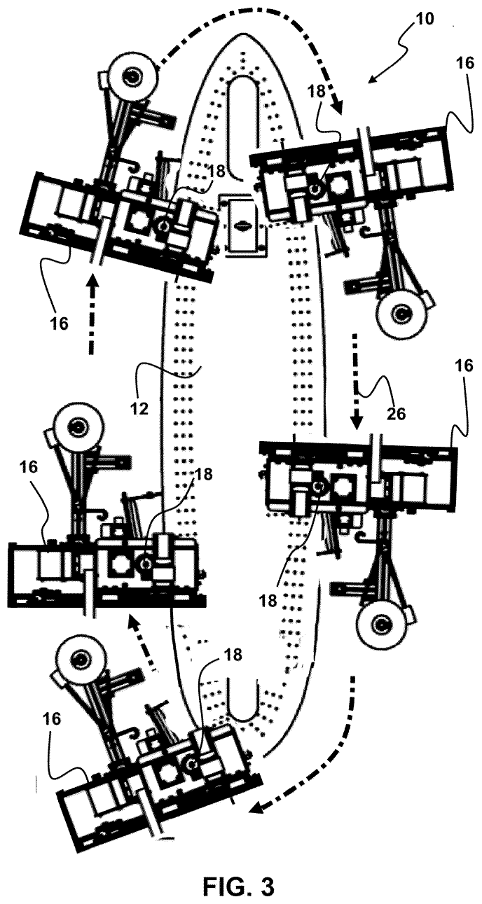

In FIG. 3, as noted, is a depiction of one shape of a circumferential pathway 26, which the welding component 16 can follow around a fabric product 12. Essentially this circumferential pathway 26 is of a shape substantially the same as a shape as a perimeter edge of the fabric product 12 being welded. A rectangular shape product 12 yields a substantially rectangular shaped circumferential pathway 26 and other product 12 shapes will change the circumferential pathway 26 to substantially match the perimeter edge thereof.

The cross member 20 as can be seen in FIG. 4 is in a sliding coupling 22 with the support member, or members, 24 such that it will slide thereon. As can be discerned from FIGS. 3-4, in operation, while welding an edge portion 33 positioned within the opening 37, the side edge portion of the stacked layers forming the fabric product 12 may be substantially parallel to a support member 24. To form the weld of the edge portion 33 while in the opening 37, the cross member 20 may be slid thereon to move the welding component 16.

As the circumferential pathway 26 for the welding of the edge portion 33 of the fabric product 12 requires an end or side, which runs traverse to the support member 24, the welding component 16 may be rotated on the rotational coupling 18 as the weld of the edge portion 33 follows around a curve or corner. Additionally, where the rotational coupling 18 is engaged with a sliding mount 25 to the cross member 20, the welding component 16 may be both rotated and slid during use.

The welding of the edge portion 33 along the opposite side of the edge portion 33 of the fabric product 12, as seen in FIG. 2, proceeds after turning the corner wherein the welding component 16 can be moved in the rotational coupling 18 thereof using the sliding mount 25 on the cross member 20b movement on the sliding coupling 22 on the support members 24. Thus the stacked layers of polymeric material need not be removed from support by the table 14 or platform nor substantially repositioned thereon.

As noted, in FIG. 3 is depicted the circumferential pathway 26, which the welding component 16 may follow to form the weld along an edge portion 33 with any fabric product 12 of multiple shapes, while the stack or layers 34 are positioned on the table 14. While shown as an oval or elliptical shape, other shapes may be just as easily welded around a perimeter or circumferential edge by the device 10. The sliding coupling 22 of the cross member 20 along with the rotational coupling 18 of the welding component 16 enables this functionality.

FIG. 4 shows the welding component 16 rotationally coupled 18 to the cross member 20. While depicted as a motor-aided rotational engagement where power may be supplied by a motor 28 to rotate the welding component 16, other rotational engagements such as a bolt and bearing or wheel or the like may be employed and as such the rotational coupling 18 may be any rotational coupling of the welding component 16 to the cross member 20. Electric power for operation of the various parts of the welding component 16 may be provided by a coiled or flexible power cord 30 which communicates electric power from a source to all parts of the welding component 16 requiring it.

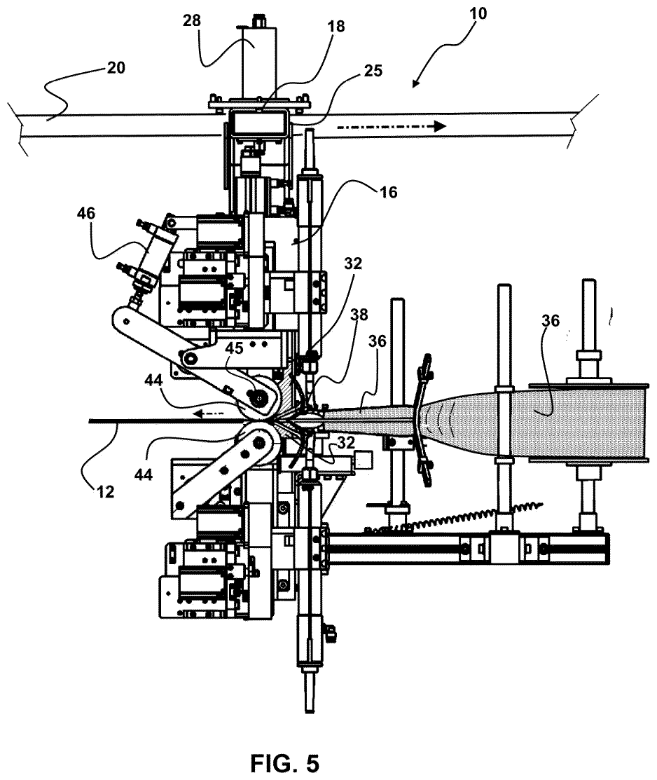

Also shown on FIG. 4, and in FIG. 5, are preferred parts of the welding component 16. As shown, a welder 32 is positioned to weld or fuse the sheets or layers 34 forming the fabric component 12 having an edge portion 33 located within the opening 37. The welder 32 may be any heat generating component which will fuse or weld the edge portions 33 of multiple layers 34 at or adjacent their respective perimeter edges to each other. Such for example, and in no way limiting, may be hot air welding, RF welding, hot wedge welding, or ultrasonic welding.

As shown in FIGS. 4-5, hot air generators 17 may direct heated airflow to the welding area or edge portion 33 where a reinforcing segment 36 may be directed through a folder 38 to form a curved contact welded against both of the two layers 14 with the reinforcing segment 36. The heat therefrom will concurrently weld the reinforcing segment 36 to both of the two layers 34 and around the perimeter or circumferential edge portion 33 of the fabric product 12 as it is being pulled thorough the opening 37 and folder 38 therein.

The folder may also be configured to fold the distal ends of each of the two layers 14 of polymeric material to form curves of both of the two layers 14 at the edge portion 33 being welded. As shown in the enlarged area, small distal portions 35 of each of the two layers 14 may also be folded back by the folder 38 and into the interior cavity 39 of the product 12 such as an inflatable surfboard or kayak.

Also shown in FIG. 4 is a reinforcing layer or segment 36 which can be concurrently welded or otherwise adhered around the perimeter or circumferential edge of the fabric product 12 as it is being welded at the edge portions 33. The material forming the reinforcing segment 36 may be the same as that of the fabric product 12 such as a polymeric material, and may be positioned on a roll as depicted, which will unwind and be pulled through a folder 38 which will wrap it around the perimeter edge of the fabric product 12 while running through the opening 37 of the welding component 16.

The sliding coupling of the cross member 20 to a support member 24 is shown in FIG. 4 as a roller 40 running in a track 42 on the support member 24. However, any sliding coupling of the cross member 20 to one, or a plurality, of support members 24 which will maintain the cross member 20 therebetween and allow it to easily slide may be employed.

Additionally, shown in FIG. 5 are opposing rollers 44 through which the perimeter or circumferential edge portion 33 of the two layers 14 forming the fabric product 12 is drawn during the welding process. The rollers 44 are rotationally coupled to roller members 45 and they may be biased toward and against each other by a biasing component 46. Such a biasing component 46 may be a spring, a solenoid, a hydraulic cylinder, or other biasing component, which will force the rollers 44 toward and/or against each other during operation of the device 10 to form a compressive engagement of the circumferential edge of the fabric product 12 therebetween. This compressive engagement has been shown to aid in maintaining the layers 44 of the polymeric fabric aligned during the welding process. At least one of the rollers 44 may be powered to provided powered pulling of the edge portion 33 during production. Such may be by geared connection to a motor or for example only, by a motor 45 engaged with at least one of the rollers 44.

Movement of the welding component 16 around the circumferential pathway 26 may be accomplished by a user pushing the welding component 16 to cause it to slide and rotate as needed to move the edge portion 33 through the opening and folder. In the alternative, an electric motor may be used for a powered sliding of the cross member 20 on the support members 24.

As noted above, while the present multilayer polymeric fabric welding system invention has been described herein with reference to particular embodiments thereof and steps in the method of employment of the modes thereof, a latitude of modifications, various changes and substitutions are intended in the foregoing disclosures, it will be appreciated that in some instances some features or steps in the configuration of welding invention could be employed without a corresponding use of other features without departing from the scope of the invention as set forth in the following claims. All such changes, alternations, and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A welder for welding an edge portion of stacked layers of polymeric material, comprising:
a welding component, said welding component in a rotational coupling to a cross member;
said cross member slidably coupled to a support member;
said welding component having an opening, said opening for positioning of an edge portion of a product positioned on a support surface;
a welder coupled to said welding component;
said welding component moveable in a circumferential pathway around a perimeter edge of said product with said edge portion sliding in said opening, without substantially moving a central portion of said product upon said support surface; and
said welder operable for welding together stacked material layers forming said product which are located at said edge portion, as said welding component moves in said circumferential pathway.

2. The welder for welding an edge portion of stacked layers of polymeric material of claim 1, additionally comprising:
a folder, said folder for folding a reinforcing segment around said edge portion; and
said welder operable to weld said reinforcing segment to said edge portion as said welding component moves along said circumferential pathway.

3. The welder for welding an edge portion of stacked layers of polymeric material of claim 1, additionally comprising:
a pair of biased rollers positioned adjacent said opening;
said biased rollers configured for imparting compression to said edge portion.

4. The welder for welding an edge portion of stacked layers of polymeric material of claim 2, additionally comprising:
a pair of biased rollers positioned adjacent said opening;
said biased rollers configured for imparting compression to said edge portion.

5. The welder for welding an edge portion of stacked layers of polymeric material of claim 1, additionally comprising:
said cross member slidably coupled to a first said support member at a first end of said cross member, and to a second said support member a second end of said cross member.

6. The welder for welding an edge portion of stacked layers of polymeric material of claim 2, additionally comprising:
said cross member slidably coupled to a first said support member at a first end of said cross member, and to a second said support member a second end of said cross member.

7. The welder for welding an edge portion of stacked layers of polymeric material of claim 3, additionally comprising:
said cross member slidably coupled to a first said support member at a first end of said cross member, and to a second said support member a second end of said cross member.

8. A method of forming a product with the device of claim 1 comprising:
positioning said stacked material layers which form said product atop a support surface;
lifting said edge portion from said support surface to position it within said opening of said welding component;
sliding said edge portion through said opening while moving said welding component along said circumferential pathway; and
welding said edge portion with said welder to fuse said stacked layers at said edge portion as said welding component moves along said circumferential pathway.

9. The method of forming a product with the device of claim 1 additionally comprising the steps of:
positioning a folder for folding a reinforcing segment around said edge portion adjacent said opening;
welding said reinforcing segment to said edge portion as said welding component moves along said circumferential pathway.
